(19) United States
(12) Patent Application Publication
(10) Pub. No.: US 2011/0114546 A1
(43) Pub. Date: May 19, 2011

(54) Water Container Having Germicidal Water Purification Unit

(76) Inventors: Barry E. Barsky, Havertown, PA (US); Jay M. Silverman, Huntingdon Valley, PA (US)

(21) Appl. No.: 12/620,336

(22) Filed: Nov. 17, 2009

(51) Int. Cl. C02F 1/32

(52) U.S. Cl. 210/143; 210/199; 210/177

(57) ABSTRACT

A water container having a germicidal water purification unit. Water stored in a reservoir passes through a conduit that extends through an array of light sources that operate in at least one of the visible light frequency range and the ultraviolet frequency range to purify the water. The light sources are activated, preferably on a selected as needed basis, by a power supply.

### FIELD OF THE INVENTION

The present invention relates, in general, to water purification and, in particular, to water containers, such as water canteens, water bottles, water bags and other portable water containers, having a germicidal water purification unit that includes light sources operating in the visible light frequency range or the ultraviolet frequency range to kill microbiological pathogens present in the water stored in such relatively small water containers.

### BACKGROUND OF THE INVENTION

It is well known that specific microbiological organisms that can be harmful or distasteful to consumers are present in water that is stored in relatively small water containers, such as water canteens, water bottles, water bags and other portable water containers. The presence of these microbiological organisms in water stored in such containers can be the result of:

(1) a problem with the water treatment system or the pipes through which water is distributed and from which these containers are filled in homes and public places; and

(2) contamination developed while water is stored in these containers either from the containers or introduced by users of the containers.

Some of the known microbiological pathogens are:

Coliform bacteria are common in the environment and generally are not harmful but can cause disease.

Fecal Coliform and E coli are bacteria the presence of which indicates that the water might be contaminated with human or animal wastes. Microbes in these wastes can cause short-term effects, such as diarrhea, cramps, nausea, headaches, or other symptoms.
Cryptosporidium is a parasite that enters lakes and rivers through sewage and animal waste and causes cryptosporidiosis which is a mild gastrointestinal disease. However, this disease can be severe or fatal for individuals with severely weakened immune systems. The Environmental Protection Agency and the Center for Disease Control have prepared advisories for those individuals with severely compromised immune systems who are concerned about Cryptosporidium.

Giardia lamblia is another parasite that enters lakes and rivers through sewage and animal waste. It causes gastrointestinal illness, such as diarrhea, vomiting, and cramps.

Turbidity, although having no direct health effects, can interfere with disinfection and provide a medium for microbial growth. Turbidity might indicate the presence of disease causing organisms, such as bacteria, viruses, and parasites, that can cause symptoms, such as nausea, cramps, diarrhea, and associated headaches.

The efforts of the water departments of cities and suburban communities in purifying portable water are extensive and to be admired. However, more and more incidences of illnesses, related to microbiological pathogens that escape normal germicidal treatments, are being reported.

Consequently, many private and public facilities, such as office buildings, factories, sports arenas, and recreational facilities, are equipped with a germicidal water purification system that typically is installed in proximity to the point at which the water enters the facility. As a result, consumers of water in the facility consume water that has passed through the germicidal water purification system.

Typically, such germicidal facility water purification systems are arranged with light sources disposed within the conduit through which the water passes. These light sources operate in the visible light frequency range or the ultraviolet frequency range and kill microbiological pathogens present in the water.

However, as indicated above, water purified by a facility purification system can become contaminated as the water is distributed through the pipes of the facility. Also, as indicated above, even after purified water is delivered to a facility or the water that is delivered to the facility is treated at the facility or that purified water is delivered to an outlet for consumption, contamination can occur while water is stored in containers that have been filled with purified water, either from the containers or introduced by users of the containers.

### SUMMARY OF THE INVENTION

A water container having a germicidal water purification unit, constructed in accordance with the present invention, includes a reservoir having a opening through which water passes into the reservoir for storage and out from the reservoir for consumption. This water container also includes a germicidal water purification unit having a housing mounted to the reservoir at the opening in the reservoir. The germicidal water purification unit also has a conduit extending within the housing axially of the housing. The conduit has an inlet end through which water in the reservoir is received for purification by the germicidal water purification unit and an outlet end through which purified water is conducted away from the germicidal water purification unit for consumption. The water is purified by a plurality of light sources operating in at least one of the visible light frequency range and the ultraviolet frequency range and disposed along the conduit. The germicidal water purification unit also has power supply means for supplying power to the light sources to energize the light sources.

### BRIEF DESCRIPTION OF THE DRAWINGS

FIG. 1 illustrates a first embodiment of a water container, constructed in accordance with the present invention, in the form of a water canteen.

FIG. 2 illustrates a second embodiment of a water container, constructed in accordance with the present invention, in the form of a water bottle.

FIG. 3 illustrates a third embodiment of a water container, constructed in accordance with the present invention, in the form of a toddler Sippy cup.

FIG. 4 illustrates a fourth embodiment of a water container, constructed in accordance with the present invention, in the form of a thermal vacuum bottle.

FIGS. 5A and 5B illustrate a fifth embodiment of a water container, constructed in accordance with the present invention, in the form of a water bag.

FIG. 6 is a sectional view of a germicidal water purification unit constructed in accordance with the present invention.

FIG. 7 illustrates a portion of a germicidal water purification unit constructed in accordance with the present invention.

FIG. 8 is a sectional view of a portion of a germicidal water purification unit constructed in accordance with the present invention.

FIG. 9 is a sectional view of a portion of a germicidal water purification unit constructed in accordance with the present invention.

### DETAILED DESCRIPTION OF THE EMBODIMENTS OF THE INVENTION

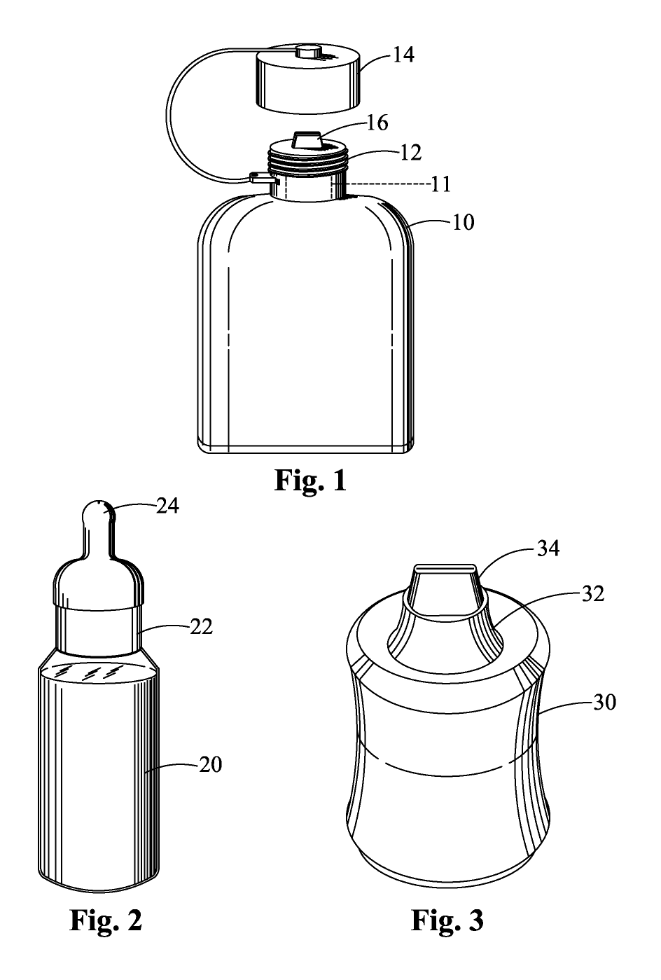

Referring to FIG. 1, which illustrates a first embodiment of a water container constructed in accordance with the present invention in the form of a water canteen, this water canteen includes a reservoir 10 and a germicidal water purification unit 12 mounted to the reservoir at an opening 11 at the top of the reservoir through which water passes into the reservoir for storage and out from the reservoir for consumption. Reservoir 10 can have a shape and size comparable to the many well-known and commercially available water canteens. Preferably, the FIG. 1 water canteen has a cap 14 tethered to reservoir 10 for sanitary reasons and to prevent inadvertent spillage.

Referring to FIG. 2, which illustrates a second embodiment of a water container constructed in accordance with the present invention in the form of a water bottle, this water bottle includes a reservoir 20 and a germicidal water purification unit 22 mounted to the reservoir at an opening (not shown) through which water passes into the reservoir for storage and out from the reservoir for consumption. Reservoir 20 can have a shape and size comparable to the many well-known and commercially available water bottles having openings through which water passes into the reservoir for storage and out from the reservoir for consumption.

Referring to FIG. 3, which illustrates a third embodiment of a water container constructed in accordance with the present invention in the form of a toddler sippy cup, this toddler sippy cup includes a reservoir 30 and a germicidal water purification unit 32 mounted to the reservoir at an opening (not shown) through which water passes into the reservoir for storage and out from the reservoir for consumption. Reservoir 30 can have a shape and size comparable to the many well-known and commercially available toddler sippy cups having openings through which water passes into the reservoir for storage and out from the reservoir for consumption.

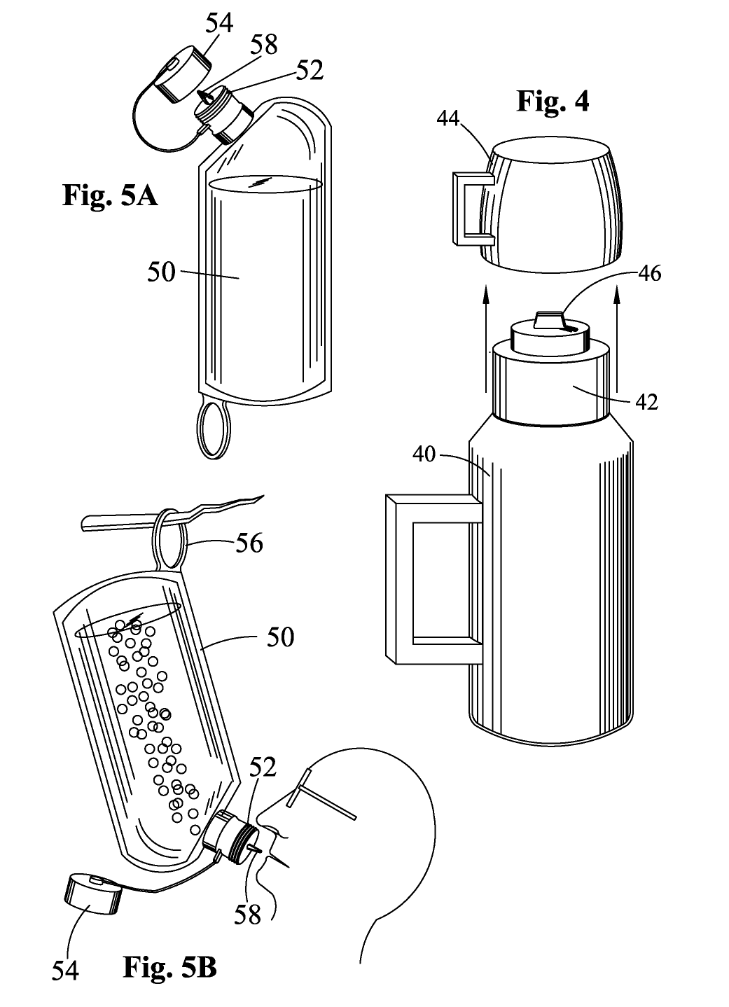

Referring to FIG. 4, which illustrates a fourth embodiment of a water container constructed in accordance with the present invention in the form of a thermal vacuum bottle, this thermal vacuum bottle includes a reservoir 40 and a germicidal water purification unit 42 mounted to the reservoir at an opening (not shown) through which water passes into the reservoir for storage and out from the reservoir for consumption. Reservoir 40 can have a shape and size comparable to the many well-known and commercially available thermal vacuum bottles having openings through which water passes into the reservoir for storage and out from the reservoir for consumption. Preferably, the FIG. 4 thermal vacuum bottle has a cap or cup 44.

Referring to FIGS. 5A and 5B, which illustrate a fifth embodiment of a water container constructed in accordance with the present invention in the form of a water bag, this water bag includes a reservoir 50 and a germicidal water purification unit 52 mounted to the reservoir at an opening (not shown) through which water passes into the reservoir for storage and out from the reservoir for consumption. Reservoir 50 can have a shape and size comparable to the many well-known and commercially available water bags having openings through which water passes into the reservoir for storage and out from the reservoir for consumption. Preferably, the FIGS. 5A and 5B water bag has a cap 54 tethered to reservoir 50 for sanitary purposes and to prevent inadvertent spillage and a hanging loop 56 that serves as a means for hanging the water bag to a tree or other support as illustrated in FIG. 5B. Including hanging loop 56 in large water containers, such as large water bags, is desirable.

FIGS. 5A and 5B illustrate the manner in which water may be stored in the reservoirs of the water containers that have been described and the manner in which the stored water may be consumed. With the water bag in the position illustrated in FIG. 5A, reservoir 50 may be filled with water. With the water bag tilted or inverted, as illustrated in FIG. 5B, water in reservoir 50 may be consumed.

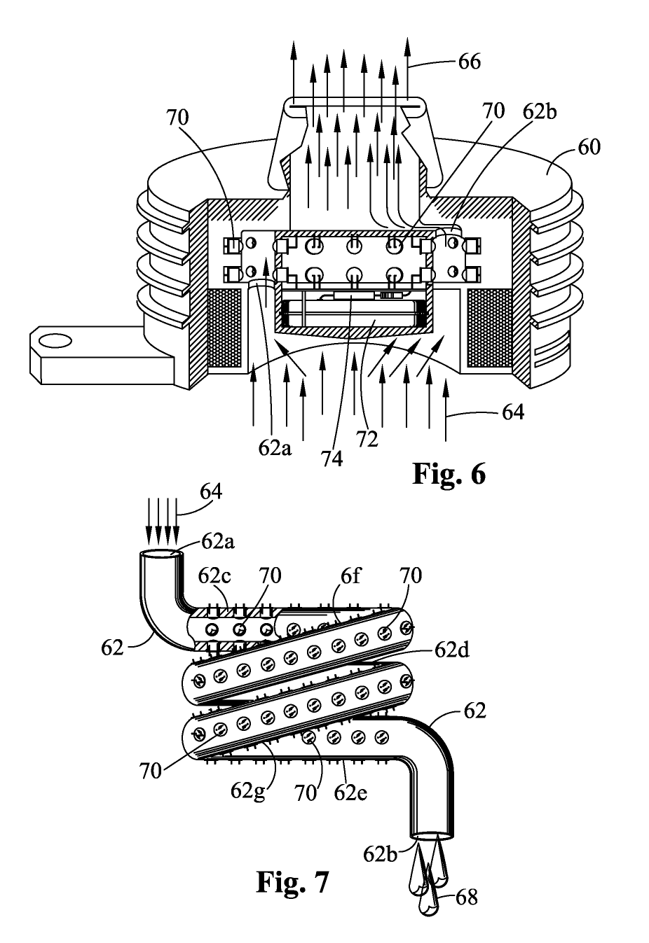

FIGS. 6, 7, 8, and 9 illustrate preferred embodiments of the germicidal water purification unit that is included in the water containers illustrated in FIGS. 1, 2, 3, 4, 5A and 5B and described above. This germicidal water purification unit includes a housing 60 mounted to one of the reservoirs described above at the opening in the reservoir through which water passes into the reservoir for storage and out from the reservoir for consumption. Housing 60 can be mounted to the reservoir by a threaded engagement or by a press fit or by other suitable means.

The germicidal water purification unit also includes a conduit 62 that extends within housing 60 axially of the housing. As shown most clearly in FIG. 7, with conduit 62 inverted for dispensing water, the conduit has an inlet end 62a through which water from the reservoir is received for purification by the germicidal water purification unit and an outlet end 62b through which the purified water is conducted away from the germicidal water purification unit for consumption. Arrows 64 in FIGS. 6 and 7 represent the introduction of water from the reservoir to the germicidal water purification unit. Arrows 66 in FIG. 6 and water drops 68 in FIG. 7 represent purified water being conducted away from the germicidal water purification unit for consumption.

To permit a clear and unobstructed viewing of the other components of the germicidal water purification unit, only input end 62a and output end 62b of conduit 62 are shown in FIG. 6. It will be understood that conduit 62, as shown in FIG. 7, is to be inverted and fitted into the germicidal water purification unit, so that water to be purified is introduced into conduit 62 through inlet end 62a of the conduit and purified water leaves the conduit through outlet end 62b of the conduit.

For the embodiments of the invention illustrated by FIGS. 1, 3, and 4, purified water is dispensed through duck bills 16, 34, and 46, respectively. For the embodiments of the invention illustrated by FIGS. 2, 5A, and 5B, purified water is dispensed through nipples 24 and 58, respectively.

Conduit 62 is formed of a material that is transparent to at least one of visible light and ultraviolet light. For the embodiment of the present invention being described, conduit 62 is helical having three horizontal sections 62c, 62d, and 62e and two inclined sections 62f and 62g. The helical form of conduit 62 increases the time of exposure of the water passing through the conduit to the purification effected by the germicidal water purification unit.

The germicidal water purification unit also includes an array of light sources 70 that operate in at least one of the visible light frequency range and the ultraviolet frequency range. Light sources 70 are disposed along conduit 62. LED's, available from Opto Technology, Inc., operating in the visible light range or at 253.7 nanometers in the ultraviolet light range can serve as the light sources 70.

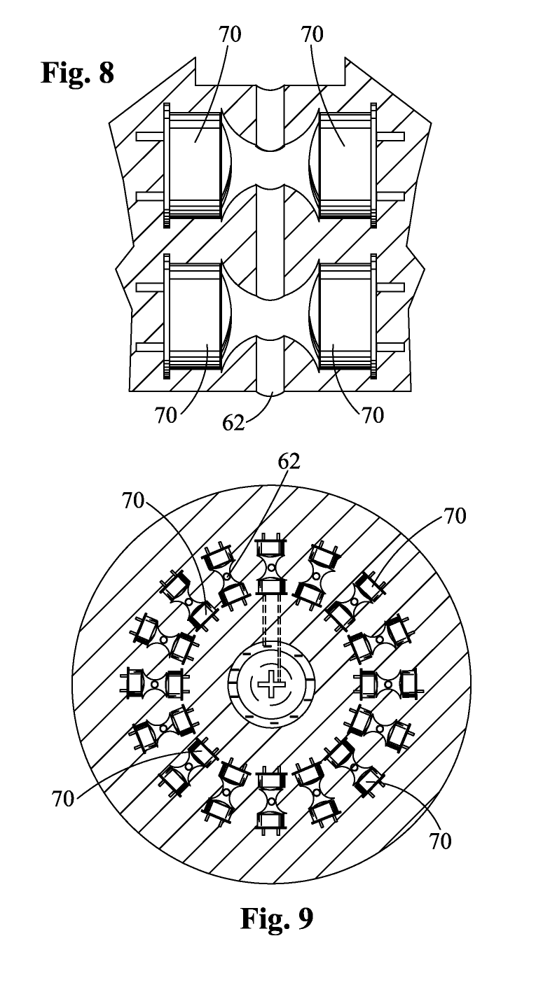

With lights sources 70 disposed along the length of conduit 62, water passing through the conduit is purified by the radiations directed radially inward from a plurality of the light sources at one side of the conduit and by the radiations directed radially outward from a plurality of the light sources at the opposite side of the conduit. The disposition of light sources 70 on opposite sides of conduit 62 is shown most clearly in FIGS. 8 and 9 with a first light source on one side of the conduit aligned with a second light source on the opposite side of the conduit.

With conduit 62 helical, the path of the water through the germicidal water purification unit is extended and the water being purified is exposed to radiations from light sources 70 for a longer period of time than would be the case if the water was conducted through a conduit, extending from the reservoir directly to the outlet of the water purification unit, in a straight-line path. The particular application of the present invention will determine the nature of the path of the water to be purified as it flows from the reservoir to the outlet. FIG. 9, for example, illustrates the light sources disposed in a pair of concentric rings when the conduit is formed in a single plane.

The germicidal water purification unit also includes power supply means for supplying power to light sources 70 to energize the light sources. Such power supply means can include a battery 72.

To conserve the power of battery 72, light sources 70 preferably are energized on an as needed basis. This is accomplished by including in the germicidal water purification unit means for selectively supplying power from battery 72 to light sources 70. Such means may be position sensing means for sensing when a water container is moved from a first position prior to consumption, as represented by FIG. 5A, that prevent the battery from supplying power to the light sources when the water container is in the first position and for sensing when the water container is repositioned for consumption of the water, as represented by FIG. 5B, to permit the battery to supply power to the light sources when the water container is in the second position. In the FIG. 6 embodiment of the germicidal water purification unit, a tilt switch 74, of conventional construction and operation, senses changes in position of the water container. When the water container is in the position illustrated in FIG. 5A, tilt switch 74 is open and battery 72 is not connected to light sources 70. When the water container is in the position illustrated in FIG. 5B, tilt switch 74 is closed and battery 72 is connected to light sources 70.

Controlling the supply of power from battery 72 to light sources 70 can also be effected by building into the outlet of the germicidal water purification unit external electrodes composed of a metallic material or an electrically conductive polymer or the like that sense body capacitance to complete a circuit to activate the light sources. Another arrangement includes a pair of metallic or polymeric electrodes, located upstream of conduit 62, that sense water flow into the germicidal water purification unit upon the dispensing of already purified water and complete a circuit to activate the light sources. Yet another way of completing a circuit to activate the light sources is to dispense the purified water through a spigot which, when actuated to dispense water, closes a switch or relay that connects the power supply to the light sources.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A water container having a germicidal water purification unit comprising:
a reservoir having an opening through which water passes into said reservoir for storage and out from said reservoir for consumption; and
a germicidal water purification unit having:
(a) a housing mounted to said reservoir at said opening in said reservoir,
(b) a conduit extending within said housing axially of said housing and having:
(1) an inlet end through which water in said reservoir is received for purification by said germicidal water purification unit, and
(2) an outlet end through which purified water is conducted away from said germicidal water purification unit for consumption,
(c) a plurality of light sources operating in at least one of the visible light frequency range and the ultraviolet frequency range and disposed along said conduit, and
(d) power supply means for supplying power to said light sources to energize said light sources.

2. A water container according to claim 1 wherein:
(a) said light sources are disposed in a pair of concentric rings, and
(b) said conduit extends between said pair of concentric rings of said light sources.

3. A water container according to claim 1 wherein said conduit is helical.

4. A water container according to claim 1 wherein said power supply means include:
(a) a power supply, and
(b) means for selectively supplying power from said power supply to said light sources to selectively energize said light sources.

5. A water container according to claim 3 wherein a first light source on one side of said conduit is aligned with a second light source on the opposite side of said conduit.

6. A water container according to claim 3 wherein said power supply means include:
(a) a power supply, and
(b) means for selectively supplying power from said power supply to said light sources to selectively energize said light sources.

7. A water container according to claim 5 wherein said power supply means include:
(a) a power supply, and
(b) means for selectively supplying power from said power supply to said light sources to selectively energize said light sources.

8. A water container according to claim 7 wherein a first light source on one side of said conduit is aligned with a second light source on the opposite side of said conduit.

9. A water container according to claim 8 wherein said power supply means include position sensing means, disposed between said power supply and said light sources, for sensing when:
(a) said reservoir is in a first position for storage of water in said reservoir to prevent said power supply from supplying power to said light sources to energize said light sources, and
(b) said reservoir is in a second position for consumption of water from said reservoir to permit said power supply to supply power to said light sources to energize said light sources.

10. A water container having a germicidal water purification unit comprising:
a reservoir having an opening through which water is introduced for storage in said reservoir and from which water stored in said reservoir is dispensed; and
a germicidal water purification unit mounted to said reservoir having:
(a) an array of light sources operating in at least one of the visible light frequency range and the ultraviolet frequency range, and
(b) a conduit extending through said array of light sources for conducting water from said reservoir to said opening in said reservoir, and
(c) power supply means for selectively supplying power to said light sources to energize said light sources.

11. A water container according to claim 10 wherein:
(a) said light sources are disposed in first and second concentric rings, and
(b) said conduit extends between said first and second rings of said light sources.

12. A water container according to claim 10 wherein said conduit is helical.

13. A water container according to claim 1 wherein said water container is a water canteen.

14. A water container according to claim 1 wherein said water container is a water bottle.

15. A water container according to claim 1 wherein said water container is a toddler sippy cup.

16. A water container according to claim 1 wherein said water container is a thermal vacuum bottle.

17. A water container according to claim 1 wherein said water container is a water bag.
